(19) United States
(12) Patent Application Publication
(10) Pub. No.: US 2020/0074060 A1
(43) Pub. Date: Mar. 5, 2020

(54) USER AUTHENTICATION DEVICE AND METHOD FOR TRIGGERING USER-SPECIFIC TARGET OPERATION

(71) Applicant: LG Electronics Inc., Seoul (KR)

(72) Inventor: Soo-Hwan OH, Seoul (KR)

(21) Appl. No.: 16/557,067

(22) Filed: Aug. 30, 2019

(30) Foreign Application Priority Data
Aug. 22, 2019 (KR) 10-2019-0102978

(51) Int. Cl. G06F 21/32; G06F 21/34; G06N 5/04; G06K 9/00

(52) U.S. Cl. CPC G06F 21/32; G06F 21/34; G06K 9/00335; G06K 9/00892; G06N 5/04

(57) ABSTRACT

Provided are user authentication devices and methods for triggering a user-specific target operation in which when a user is authenticated using biometric information in an autonomous driving vehicle, each user-specific target operation registered for each individual is provided and selected in a biometric authentication process. The device and method may be associated with an AI device, a drone, an UAV, a robot, an AR device, a VR device, and a 5G service.

### CROSS-REFERENCE TO RELATED APPLICATIONS

The present disclosure claims priority to and the benefit of Korean Patent Application No. 10-2019-0102978, filed on Aug. 22, 2019, the disclosure of which is incorporated herein by reference in its entirety.

### BACKGROUND

### 1. Technical Field

The present disclosure relates to user authentication devices and methods for triggering a user-specific target operation in which when a user is authenticated using biometric information in an autonomous driving vehicle, each user-specific target operation registered for each individual is selected in a biometric authentication process.

### 2. Description of the Related Art

Currently, features used in a biometric recognition system include faces, voices, hand shapes, irises, veins, fingerprints, etc. A biometric recognition system for each feature is actively researched.

In particular, biometric recognition technology is employed in portable electronic devices such as smartphones. Recently, with spread of autonomous driving technology and popularization of shared vehicles, biometric recognition technology is expected to become more common to provide personal identification and personal customized services for vehicles.

Among various biometric recognitions, a fingerprint recognition is the most widely adopted. The fingerprint identification has advantages of being more secure and high availability than other biometric recognition technologies.

However, due to cost and space constraints of fingerprint sensors, the sensors are very small in size and usually receive only a very small portion of the fingerprint. As such, when only a part of the fingerprint is used, a security level is low due to insufficient feature information.

The security level is usually determined based on a false acceptance rate. In a fingerprint recognition using a full fingerprint, the false acceptance rate is about 1/one hundred million. However, in a fingerprint recognition using only a portion of a fingerprint, for example in portable electronic devices, it is almost impossible to reduce the false acceptance rate to about to 1 of 100,000 or smaller.

Therefore, it is very risky to use the fingerprint recognition function employed in the portable electronic device for performing payment or using a financial service requiring a very high security level.

According to a prior art, in order to improve the security of biometric recognition such as the fingerprint recognition, additional means such as password authentication and gesture authentication were used. In one example, recognizing an additional motion (gesture) at the same time as a face recognition is used.

However, this may impose, to the user, burden of remembering the additional information such as passwords and gestures. Thus, there is a problem that it is inconvenient to add an additional input for biometric recognition. In particular, since a control input for user-specific target operation selection is fixed, it is inconvenient for the user to learn a manual. That is, since the user should remember and input a specific control input each time, the user may forget the specific control input.

Further, a conventional approach uses biometric authentication and motion authentication for user authentication. In this case, there is a problem that the usability is inferior as the user authentication is performed at all times by performing both the biometric authentication and motion authentication.

### SUMMARY

A purpose of the present disclosure is to provide user authentication devices and methods for triggering a user-specific target operation in which when a user is authenticated using biometric information in an autonomous driving vehicle, each user-specific target operation registered for each individual is provided and selected in a biometric authentication process.

Further, another purpose of the present disclosure is to provide user authentication devices and methods for triggering a user-specific target operation in which even when both biometric authentication and motion authentication are used for user authentication, a single biometric authentication may suffice such that a further authentication process is not necessary.

Further, another purpose of the present disclosure is to provide user authentication devices and methods for triggering a user-specific target operation in which motion authentication is specific to each user such that the same motion authentication have different purposes between users.

Further, another purpose of the present disclosure is to provide user authentication devices and methods for triggering a user-specific target operation in which additional motion authentication in a biometric authentication process may enhance a security level of the biometric authentication.

Further, another purpose of the present disclosure is to provide user authentication devices and methods for triggering a user-specific target operation in which when not performing motion authentication, a user's selectable motion is determined by a biometric authentication process to enhance the user convenience.

Further, another purpose of the present disclosure is to provide user authentication devices and methods for triggering a user-specific target operation in which when a motion difficulty level for motion authentication is high, a motion for triggering a user-specific target operation may be automatically selected depending on vehicle's interior and exterior conditions.

Purposes of the present disclosure are not limited to the above-mentioned purpose. Other purposes and advantages of the present disclosure as not mentioned above may be understood from following descriptions and more clearly understood from embodiments of the present disclosure. Further, it will be readily appreciated that the purposes and advantages of the present disclosure may be realized by features and combinations thereof as disclosed in the claims.

In accordance with the present disclosure, a user authentication device and method for triggering a user-specific target operation according to the present disclosure compares at least one of obtained biometric data and motion data with loader data that has been stored in advance and verifies at least one of the biometric authentication or biometric authentication and motion authentication based on the comparison result to authenticate a user.

In accordance with the present disclosure, a user authentication device and method for triggering a user-specific target operation according to the present disclosure may provide a user with a motion information guide to input a registered motion, and may recommend a registered motion based on acquired environment data.

In accordance with the present disclosure, a user authentication device and method for triggering a user-specific target operation according to the present disclosure may recommend at least one of a motion that can be selected by a user based on acquired environment data, a motion that is easily recognized by a motion recognition unit, or a motion with the highest frequency of uses by the user under a condition of environment data.

In a first aspect, there is proposed a user authentication device comprising: a recognition unit configured for extracting biometric information and motion information of a user and environment information including vehicle and user status to obtain at least one of biometric data, motion data, or environment data; an authentication unit configured for: comparing at least one of the obtained biometric data or motion data with previously stored loader data; verifying biometric authentication and/or motion authentication based on the comparison result; and performing user authentication based on the verification result; a motion processing unit configured for, when the biometric authentication is successful and a pre-registered motion corresponding to the successful biometric authentication is present, notifying the pre-registered motion to the user; and a user-specific target operation presentation unit configured for presenting, to the user, a pre-stored user-specific target operation based on the user authentication result.

In a second aspect, there is proposed a user authentication method comprising: extracting, by a recognition unit, biometric information and motion information of a user and environment information including vehicle and user status to obtain at least one of biometric data, motion data, or environment data; comparing, by an authentication unit, at least one of the obtained biometric data or motion data with previously stored loader data; verifying, by the authentication unit, biometric authentication and/or motion authentication based on the comparison result; performing, by the authentication unit, user authentication based on the verification result; when the biometric authentication is successful and a pre-registered motion corresponding to the successful biometric authentication is present, notifying, by the motion processing unit, the pre-registered motion to the user; and presenting, by a user-specific target operation presentation unit, to the user, a pre-stored user-specific target operation based on the user authentication result.

In a third aspect, there is proposed a user authentication method comprising: acquiring biometric data from biometric information extracted from a biometric recognition unit; verifying, by a biometric authentication unit, biometric authentication by comparing the biometric data with previously stored biometric loader data; verifying, by a registered motion verifying unit, whether there is a registered motion corresponding to a successful biometric authentication; when, upon the verification result, there is no registered motion corresponding to the biometric authentication, providing a user with a user-specific target operation corresponding to the biometric authentication; when, the verification result, there is a registered motion corresponding to the biometric authentication, extracting, by a motion recognition unit, motion information to obtain motion data; verifying, by a motion authentication unit, motion authentication by comparing the acquired motion data with previously stored motion loader data; and providing a user with a user-specific target operation corresponding to the successfully verified motion authentication.

Effects of the present disclosure are as follows but are not limited thereto.

In accordance with the user authentication devices and methods for triggering a user-specific target operation in accordance with the present disclosure, when a user is authenticated using biometric information in an autonomous driving vehicle, each user-specific target operation registered for each individual is provided and selected in a biometric authentication process.

Further, in accordance with the user authentication devices and methods for triggering a user-specific target operation in accordance with the present disclosure, even when both biometric authentication and motion authentication are used for user authentication, a single biometric authentication may suffice such that a further authentication process is not necessary.

Further, in accordance with the user authentication devices and methods for triggering a user-specific target operation in accordance with the present disclosure, motion authentication is specific to each user such that the same motion authentication have different purposes between users.

Further, in accordance with the user authentication devices and methods for triggering a user-specific target operation in accordance with the present disclosure, additional motion authentication in a biometric authentication process may enhance a security level of the biometric authentication.

Further, in accordance with the user authentication devices and methods for triggering a user-specific target operation in accordance with the present disclosure, when not performing motion authentication, a user's selectable motion is determined by a biometric authentication process to enhance the user convenience.

Further, in accordance with the user authentication devices and methods for triggering a user-specific target operation in accordance with the present disclosure, when a motion difficulty level for motion authentication is high, a motion for triggering a user-specific target operation may be automatically selected depending on vehicle's interior and exterior conditions.

In addition to the effects as described above, specific effects of the present disclosure are described together with specific details for carrying out the invention.

### BRIEF DESCRIPTION OF DRAWINGS

FIG. 1 is a block diagram of a user authentication device for triggering a user-specific target operation according to an embodiment of the present disclosure.

FIG. 2 illustrates an embodiment describing a user authentication method for triggering a user-specific target operation according to the present disclosure.

FIG. 3 shows another embodiment describing a user authentication method for triggering a user-specific target operation according to the present disclosure.

FIG. 4 is another embodiment describing a user authentication method for triggering a user-specific target operation according to the present disclosure.

FIG. 5A illustrates an embodiment of sequentially performing biometric authentication and motion authentication in a user authentication device for triggering a user-specific target operation according to the present disclosure.

FIG. 5B shows an embodiment of performing biometric authentication and motion authentication in a parallel manner in a user authentication device for triggering a user-specific target operation according to the present disclosure.

FIG. 6 is a flow chart describing a user authentication method for triggering a user-specific target operation according to an embodiment of the present disclosure.

FIG. 7 is a flow chart describing a user authentication method for triggering a user-specific target operation of the present disclosure for enhanced security.

FIG. 8 is a flow chart describing a user authentication method for triggering a user-specific target operation of the present disclosure for enhanced convenience.

### DETAILED DESCRIPTIONS

For simplicity and clarity of illustration, elements in the figures are not necessarily drawn to scale. The same reference numbers in different figures denote the same or similar elements, and as such perform similar functionality. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

In addition, it will also be understood that when a first element or layer is referred to as being present “on” or “beneath” a second element or layer, the first element may be disposed directly on or beneath the second element or may be disposed indirectly on or beneath the second element with a third element or layer being disposed between the first and second elements or layers. It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, user authentication devices and methods for triggering a user-specific target operation according to some embodiments of the present disclosure will be described.

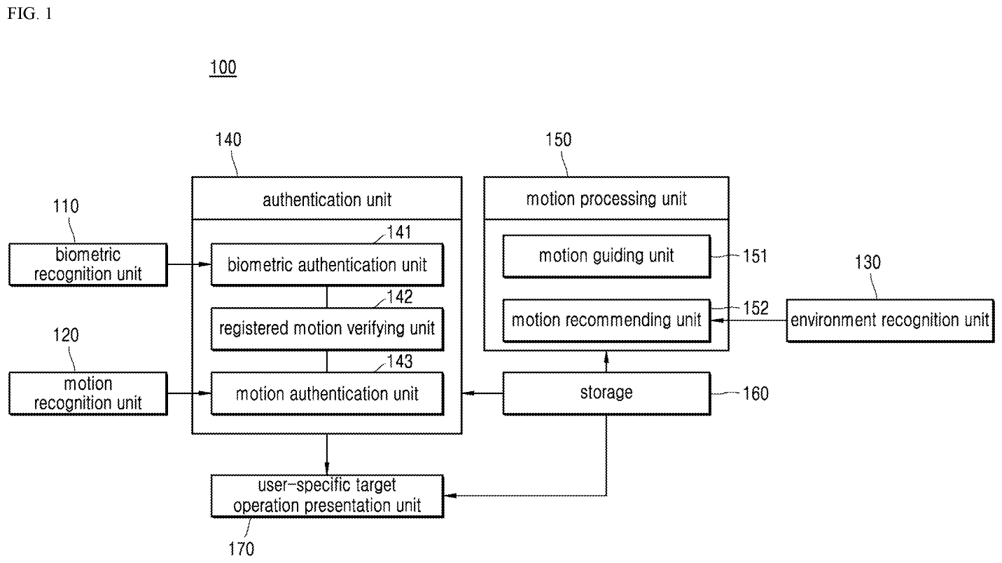

FIG. 1 is a block diagram of a user authentication device for triggering a user-specific target operation according to an embodiment of the present disclosure. A user authentication device 100 for triggering a user-specific target operation shown in FIG. 1 is merely based on one embodiment. Thus, components thereof are not limited to the embodiment shown in FIG. 1. Some components may be added, changed or deleted as necessary.

As shown in FIG. 1, the user authentication device 100 includes a biometric recognition unit 110, a motion recognition unit 120, an environment recognition unit 130, an authentication unit 140, a motion processing unit 150, a storage 160, and a user-specific target operation presentation unit 170.

The biometric recognition unit 110 extracts biometric information of the user and acquires biometric data of the user. In this connection, biometric information may include fingerprints, veins, retinas, irises, voices, and images. The biometric recognition unit 110 may include a fingerprint authentication sensor that may recognize the user's fingerprint and a camera that may recognize the user's iris. However, the biometric recognition unit 110 is not limited thereto. the biometric recognition unit 110 may be include variety of recognizing unit that may recognize at least one of biometric information such as fingerprint, vein, retina, iris, voice, and image.

The motion recognition unit 120 extracts motion information of the user to obtain motion data. In this connection, motion information may include gesture, text, position of touch point, shape and area. The motion recognition unit 120 may include a camera that may recognize a user's hand position, number of fingers, hand direction, an area covered by the hand, eye gaze, eye blinking, facial expression, facial angle, mouth shape, or the like. The motion recognition unit 120 may include a voice recognizer (STT: speech to text) that converts the spoken content into text. However, the motion recognition unit 120 is not limited thereto but may include a variety of recognizers that may recognize motion information.

The environment recognition unit 130 extracts environment information around the user to obtain environment data. In this connection, the environment information may include information indicating vehicle state and user situation, such as brightness, noise, vehicle position, current time, current weather, vehicle driving status, or autonomous driving status. The environment recognition unit 130 may include a sensor that may detect temperature, snow, rain, and humidity or a sensor that can detect ambient brightness, or a receiver that can receive vehicle and user situation information from an external device or server. However, the environment recognition unit 130 is not limited thereto. The environment recognition unit 130 may include various sensors or receivers that may recognize and detect the environment information such as brightness, noise, current time, current weather, vehicle position and vehicle driving state, autonomous driving state, and user situation.

The authentication unit 140 compares at least one of the biometric data acquired from the biometric recognition unit 110 and the motion data obtained from the motion recognition unit 120 with loader data stored in the storage 160, and then verifies either biometric authentication or biometric authentication and motion authentication to authenticate the user.

To this end, the authentication unit 140 may include a biometric authentication unit 141 for verifying biometric authentication by comparing the biometric data acquired from the biometric recognition unit 110 with the biometric loader data stored in the storage 160, and a motion authentication unit 143 for verifying motion authentication by comparing the motion data acquired from the motion recognition unit 120 with the motion loader data stored in the storage 160. The authentication unit 140 may include registration verifying unit to check if there is a motion pre-registered in the storage 160 corresponding to the biometric authentication when the motion data is not obtained from the motion recognition unit 120.

In this connection, if there is no registered motion corresponding to the biometric authentication, the authentication unit 140 authenticate the user only using the biometric authentication result verified by the biometric authentication unit 141. Further, if there is a registered motion corresponding to the biometric authentication, the authentication unit 140 waits until the motion data is acquired by the motion recognition unit 120.

Then, if the authentication unit 140 does not acquire motion data from the recognition unit 120 after a certain time, it is determined that the user does not perform motion authentication. Therefore, if the motion recognition unit 120 does not acquire the motion data after a certain time, the authentication unit 140 may authenticate a user only using the biometric authentication results verified by the biometric authentication unit 141.

If a motion corresponding to the biometric authentication authenticated by the authentication unit 140 is registered in advance in the storage 160, the motion processing unit 150 may provide the motion information the user to input the registered motion.

To the contrary, if a motion corresponding to the biometric authentication authenticated by the authentication unit 140 is not registered in advance in the storage 160, registration information may be provided to a user so that a specific motion may be additionally registered by the user. The specific motion may include a motion that can be selected according to environmental data before and after the biometric authentication, a motion having the highest use frequency by the user, or a motion that can be easily recognized by the motion recognition unit 120.

To this end, the motion processing unit 150 may include a motion guiding unit 151 which provides a user with a motion information guide so that the registered motion or specific motion is input by the user, and a motion recommending unit 152 for recommending the registered motion or specific motion based on the environment data acquired from the environment recognition unit 130. In this connection, when there are a plurality of registered motions or specific motions for a single biometric authentication, the motion recommending unit 152 may recommend one of these motions.

The motion recommending unit 152 may recommend a motion that can be selected by the user based on the environment data acquired by the environment recognition unit 130, a motion that is easily recognized by the motion recognition unit 120 or a motion of the highest use frequency by the user under the condition of the environment data.

For example, the motion recommending unit 152 generates, as learned data, the frequency of the motions performed by the user under conditions such as vehicle position, current time, current weather, vehicle driving state, and self-driving state. Then, the motion recommending unit 152 extracts the most frequently used motion from the generated learned data under the current condition of the user or vehicle and recommend a motion most relevant to the verified biometric authentication. This may be used when multiple motion authentications are registered for one biometric authentication.

The user-specific target operation presentation unit 170 provides an individual user-specific target operation stored in the storage 160 based on the user authentication result authenticated by the authentication unit 140.

In one example, when the user authentication device 100 authenticates a user using biometric information in an autonomous driving vehicle, the user authentication device 100 may select and provide a plurality of user-specific target operations registered for each individual in the biometric authentication process.

In this connection, the autonomous driving vehicle may be operated by a transportation company server, such as a car sharing company or may be an autonomous driving vehicle that drives to its destination without the operator's manipulation. Further, the vehicle may include any means for transportation, such as a car, a train, a motorcycle. However, an example in which the vehicle is a car will be described below for the convenience of description. Further, the shared vehicle may an internal combustion engine vehicle having an engine as a power source, a hybrid vehicle having an engine and an electric motor as the power source, and an electric vehicle having an electric motor as the power source.

Then, the autonomous driving vehicle may include a user interface device, an object detecting device, a communication device, a driving manipulation device, a main ECU, a driving control device, an autonomous driving device, a sensor, and a position data generating device. Each of the object detecting device, the communication device, the driving manipulation device, the main ECU, the driving control device, the autonomous driving device, the sensor and the position data generating device may be implemented as an electronic device for generating an electrical signal and for exchanging the electrical signal with another device.

The user interface device is configured for communicating between the autonomous driving vehicle and the user. The user interface device may receive user input, and may provide the user with information generated by the autonomous driving vehicle. The autonomous driving vehicle may implement a UI (User Interface) or a UX (User Experience) via the user interface device. The user interface device may include an input device, an output device, and a user monitoring device.

The object detecting device may generate information about an object external to the autonomous driving vehicle. The information on the object may include at least one of information on presence or absence of the object, position information of the object, distance information between the autonomous driving vehicle and the object, and relative speed information between the autonomous driving vehicle and the object. The object detecting device may detect an object external to the autonomous driving vehicle. The object detecting device may include at least one sensor that may detect an object external to the autonomous driving vehicle. The object detecting device may include at least one of a camera, a radar, a lidar, an ultrasonic sensor, and an infrared sensor. The object detecting device may provide at least one electronic device included in the vehicle with data about the object generated based on the sensing signal generated by the sensor.

The camera may generate information about the object external to the autonomous driving vehicle using the image. The camera may include at least one lens, at least one image sensor, and at least one processor. The processor is electrically connected to the image sensor and then process a received signal therefrom and generate data about an object based on the processed signal.

The camera may include at least one of a mono camera, a stereo camera, and an AVM (Around View Monitoring) camera. The camera may acquire position information of the object, distance information to the object, or relative speed information relative to the object using various image processing algorithms. For example, the camera may obtain distance information to and relative speed information with respect to the object based on a change of an object size over time in the acquired image. For example, the camera may obtain the distance information to and relative speed information with respect to the object via a pinhole model, road-face profiling, or the like. For example, the camera may obtain the distance information to and relative speed information with respect to the object based on disparity information in a stereo image acquired by a stereo camera.

The camera may be mounted at a position that allows a field of view (FOV) in the vehicle to image a scene external to the vehicle. The camera may be placed proximate to a front windshield and in an interior of the vehicle to obtain an image in front of the vehicle. The camera may be disposed adjacent to a front bumper or radiator grille. The camera may be placed proximate to a rear glass and in the interior of the vehicle to obtain an image behind the vehicle. The camera may be disposed adjacent to a rear bumper, a trunk or a tail gate. The camera may be disposed proximate to at least one of side windows and in an interior of the vehicle to obtain a right or left side image to the vehicle. Alternatively, the camera may be positioned adjacent to a side mirror, a fender or a door.

The radar may generate information about an object external to the autonomous driving vehicle using a radio wave. The radar may include an electromagnetic wave transmitter, an electromagnetic wave receiver, and at least one processor electrically connected to the electromagnetic wave transmitter and the electromagnetic wave receiver to process the received signal therefrom to generate data about an object based on the processed signal. The radar may be implemented in a pulse radar manner or a continuous wave radar manner based on a principle of the radio wave emission. The radar in the continuous wave radar manner may be classified into a FMCW (Frequency Modulated Continuous Wave) type and a FSK (Frequency Shift Keying) type based on a signal waveform. The radar detects the object using the electromagnetic wave in the TOF (Time of Flight) or phase shift manner and thus determines a position of the detected object, a distance to the detected object, and the relative speed thereto. The radar may be positioned at an appropriate position on an outer face of the vehicle to detect an object positioned in front, rear of or right or left to the vehicle.

The lidar may generate information about an object external to the autonomous driving vehicle using a laser light. The lidar may include an optical transmitter, an optical receiver and at least one processor electrically connected to the optical transmitter and the optical receiver to process a received signal therefrom for generating data about the object based on the processed signal. The lidar may be implemented in a TOF (time of flight) manner or a phase-shift manner. The lidar may be implemented in a movable or fixe manner. When the lidar is implemented in the movable manner, the lidar is rotated by a motor, and detects objects around the autonomous driving vehicle. When the lidar is implemented in a fixed manner, the lidar may detect an object positioned within a predefined range with respect to the vehicle using optical steering. The autonomous driving vehicle may include a plurality of fixed lidars. The lidar detects an object in a TOF (Time of Flight) manner or a phase-shift manner via laser light, and thus determines a position of the detected object, a distance to the detected object, and the relative speed thereto. The lidar may be positioned at an appropriate position on an outer face of the vehicle to detect an object positioned in front, rear of or right or left to the vehicle.

The communication device may exchange signals with a device external to the autonomous driving vehicle. The communication device may exchange signals with at least one of an infrastructure (for example, a server, a broadcasting station), another vehicle, or a terminal. The communication device may include at least one of a transmit antenna, a receive antenna, an RF (radio frequency) circuit capable of implementing various communication protocols, and an RF element to perform communication.

The driving manipulation device is configured to receive a user input for driving. In a manual mode, the autonomous driving vehicle may be driven based on a signal provided by the driving manipulation device. The driving manipulation device may include a steering input device such as a steering wheel, an acceleration input device such as an accelerator pedal, and a braking input device such as a brake pedal.

The main ECU may control overall operations of at least one electronic device provided in the autonomous driving vehicle.

The drive control device is configured to electrically control various vehicle drive devices in the autonomous driving vehicle. The drive control device may include a power train drive control device, a chassis drive control device, a door/window drive control device, a safety device drive control device, a lamp drive control device and an air conditioning drive control device. The power train drive control device may include a power source drive control device and a transmission drive control device. The chassis drive control device may include a steering drive control device, a brake drive control device and a suspension drive control device. In one example, the safety device drive control device may include a seat belt drive control device for seat belt control.

The drive control device includes at least one electronic control device, for example, a control ECU (Electronic Control Unit).

The drive control device may control the vehicle drive device based on the signal received from the autonomous driving vehicle. For example, the drive control device may control the power train, steering device and brake device based on the signal received from the autonomous driving vehicle.

The autonomous driving device 260 may generate a route for autonomous driving based on the obtained data. The autonomous driving device may generate a driving plan for driving along the generated route. The autonomous driving device may generate a signal for controlling movement of the vehicle according to the driving plan. The autonomous driving device may provide the generated signal to the drive control device.

The autonomous driving device may implement at least one ADAS (Advanced Driver Assistance System) function. The ADAS may implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), PD (pedestrian) collision warning, TSR (Traffic Sign Recognition), TSA (Traffic Sign Assist), NV (Night Vision), DSM (Driver Status Monitoring), and TJA (Traffic Jam Assist).

The autonomous driving device may perform a switching operation from the autonomous driving mode to a manual driving mode or a switching operation from the manual driving mode to the autonomous driving mode. For example, the autonomous driving device may switch a mode of the autonomous driving vehicle from the autonomous driving mode to the manual driving mode or from the manual driving mode to the autonomous driving mode based on the signal received from the user interface device.

The sensor may sense a state of the vehicle. The sensor may include at least one of a IMU (inertial measurement unit) sensor, a collision sensor, a wheel sensor, a speed sensor, a tilt sensor, a weight sensor, a heading sensor, a position module, a vehicle forward/rearward sensor, a battery sensor, a fuel sensor, a tire sensor, a steering sensor, a temperature sensor, a humidity sensor, an ultrasonic sensor, a luminance sensor, a pedal position sensor. In one example, the IMU (inertial measurement unit) sensor may include one or more of a acceleration sensor, a gyro sensor, and a magnetic sensor.

The sensor may generate state data of the vehicle based on a signal generated from the at least one sensor. The vehicle state data may include information generated based on the data sensed by various sensors provided in the vehicle. The sensors may generate vehicle attitude data, vehicle motion data, vehicle yaw data, vehicle roll data, vehicle pitch data, vehicle collision data, vehicle direction data, vehicle angle data, vehicle speed data, vehicle acceleration data, vehicle tilt data, vehicle forward/rearward data, vehicle weight data, battery data, fuel data, tire inflation data, vehicle internal temperature data, humidity data inside a vehicle, steering wheel rotation angle data, vehicle external illuminance data, pressure data applied to an accelerator pedal, pressure data applied to a brake pedal, etc.

The position data generating device may generate position data of the vehicle. The position data generating device may include at least one of a GPS (Global Positioning System) and a DGPS (Differential Global Positioning System). The position data generating device may generate position data of the vehicle based on a signal generated from at least one of the GPS and the DGPS. According to an embodiment, the position data generating device may correct the position data based on at least one of data from the IMU (Inertial Measurement Unit) sensor and the camera of the object detecting device. The device for generating the position data may be referred to as a GNSS (Global Navigation Satellite System).

The autonomous driving vehicle may include an internal communication system. A plurality of electronic devices included in the autonomous driving vehicle may exchange signals through an internal communication system. The signal may include data. The internal communication system may use at least one communication protocol, for example CAN, LIN, FlexRay, MOST, or Ethernet.

An operation of the user authentication device for triggering a user-specific target operation according to the present disclosure configured as described above will be described in detail with reference to the accompanying drawings.

The same reference numerals as in FIG. 1 refer to the same members performing the same functions in following drawings.

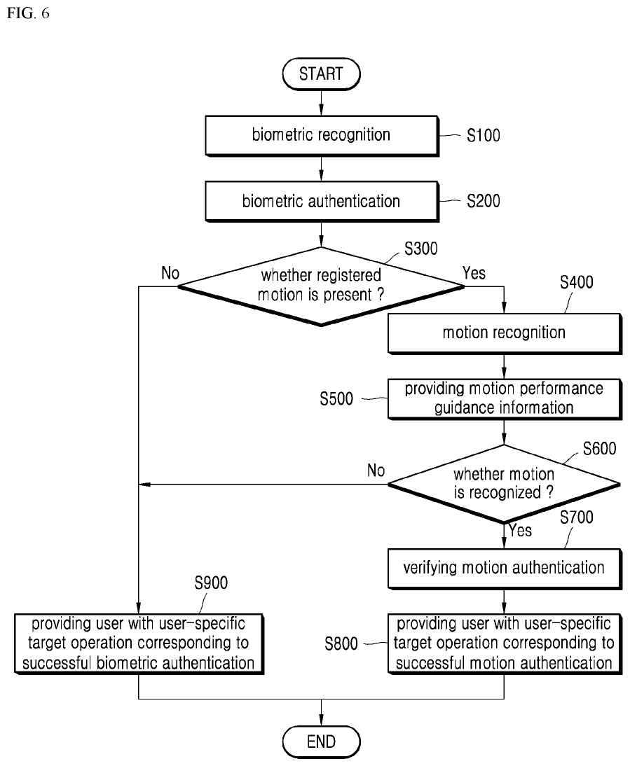

FIG. 6 is a flow chart describing a user authentication method for triggering a user-specific target operation according to an embodiment of the present disclosure.

Referring to FIG. 6, first, the biometric recognition unit 110 of the user authentication device 100 extracts biometric information of the user and then obtain biometric data using the extracted biometric information S100.

The extraction of the biometric information may include extracting the user's fingerprint information using a fingerprint authentication sensor, or extracting the user's iris information using a camera.

The biometric data may refer to template data having feature points or landmarks extracted from the biometric information. Biometric information may include fingerprints, veins, retinas, irises, voices, and images.

Subsequently, the biometric authentication unit 141 of the user authentication device 100 compares the biometric data acquired by the biometric recognition unit 110 with the biometric loader data stored in the storage 160, and verifies the biometric authentication based on the comparison result S200. The biometric loader data refers to original biometric data obtained from a subscribed user for user authentication and stored in advance in the storage 160. Thus, the biometric authentication unit 141 verifies that the biometric authentication is successful if the obtained biometric data and the biometric loader data are the same. Further, if the acquired biometric data and biometric loader data are not the same, the unit 141 may verify that the biometric authentication has failed.

The registered motion verifying unit 142 of user authentication device 100 checks whether there is a pre-registered motion corresponding to the verified biometric authentication, that is, the successfully verified biometric authentication S300. Pre-registered motion corresponding to the biometric authentication may be registered by the user or may be configured by the user.

The motion preregistration may be performed to select the user-specific target operations. The selection of the user-specific target operations may be intended to enhance security or improve convenience. The enhanced security may prevent illegal authentication via double authentication procedures. The convenience improvement may be achieved by varying the security level based on the type of the user-specific target operation. That is, a user-specific target operation having a low level of the security may be quickly accessed. In other words, the user authentication device 100 may vary the type of the user-specific target operation to be accessed depending on a case where only the biometric authentication succeeds and the case where both the biometric authentication and the motion authentication succeed.

When, from the verification result S300, there is no pre-registered motion corresponding to the verified biometric authentication, the user authentication device 100 may provide a user with a user-specific target operation corresponding to biometric authentication S900.

In this connection, if a motion corresponding to the biometric authentication authenticated by the authentication unit 140 is not registered in advance in the storage 160, the motion processing unit 150 may provide registration information to a user so that a specific motion may be additionally registered by the user. The specific motion may include a motion that can be selected according to environmental data before and after the biometric authentication, a motion having the highest use frequency by the user, or a motion that can be easily recognized by the motion recognition unit 120.

That is, the motion recommending unit 152 may recommend a specific motion based on the environment data acquired by the environment recognition unit 130. In one example, the motion recommending unit 152 generates, as learned data, the frequency of the motions performed by the user under conditions such as vehicle position, current time, current weather, vehicle driving state, and self-driving state. Then, the motion recommending unit 152 extracts the most frequently used motion from the generated learned data under the current condition of the user or vehicle and recommend a motion most relevant to the verified biometric authentication.

Thus, even when there is no registered motion, the user authentication device 100 may identify a motion pattern of the user before and after the authentication to guide the user to additionally register a specific motion when authenticating the user.

When, from the verification result S300, there is a pre-registered motion corresponding to the verified biometric authentication, the user authentication device 100 extracts motion information of the user using the motion recognition unit 120 to acquire motion data S400. In this connection, the process of acquiring the motion data may be performed together the process S100 of acquiring the biometric data.

In one example, the extraction of motion information may involve extractin of the user's hand (hand position, number of fingers, hand direction, the area covered by the hand), eyes (eye direction, eye blinking), facial expression, facial angle, or mouth shape using the camera. Alternatively, for the extraction of motion information, a voice recognizer (STT: speech to text) converts the spoken content into text.

The motion data may refer to template data having feature points or landmarks extracted from the motion information. The motion information may include gesture, text, position of touch point, shape and area.

In this connection, if no motion data is obtained, or if the obtained motion data is not a registered motion, the motion processing unit 150 of the user authentication device 100 may provide motion performance guidance information to the user so that the user performs the registered motion S500. The motion performance guide information may be provided on a display or via a speaker provided in a vehicle or a user device.

The motion performance guide information may include a motion information guide provided by the motion guiding unit 151 and a motion recommendation provided by the motion recommending unit 152.

The motion information guide refers to information indicating a hint of a motion registered by the user. In one example, if the motion of the finger shaping “V” is registered, the motion guiding unit 151 may provide the user with a number “2” as a hint. The motion information guide may be used when only one motion authentication corresponding to the verified biometric authentication is registered. That is, when a plurality of motion authentications are registered for a single biometric authentication, a motion information guide different from the user's intention may be provided when providing the motion information guide to the user.

The motion recommendation refers to a motion selected and recommended based on the environment data acquired by the environment recognition unit 130. In this connection, the recommended motion may include a user motion which is selectable based on the environment data, or a motion that is easily recognized by the motion recognition unit 120 or a motion with the highest use frequency by the user under the environment data condition.

Regarding one example of the motion recommendation information, the motion recommending unit 152 generates, as learned data, the frequency of the motions performed by the user under conditions such as vehicle position, current time, current weather, vehicle driving state, and self-driving state. Then, the motion recommending unit 152 extracts the most frequently used motion from the generated learned data under the current condition of the user or vehicle and recommend a motion most relevant to the verified biometric authentication. This may be used when multiple motion authentications are registered for one biometric authentication.

In one example, the motion processing unit 150 of the user authentication device 100 provides the motion performance guidance information to the user. Then, the user authentication device 100 waits for a predetermined time (about 5 seconds) until the motion data is acquired. Then, if motion data is still not acquired after the about 5 seconds has elapsed, the authentication unit 140 may determine that the user does not perform separate motion authentication S600.

As such, if no motion data is acquired after a certain time, the user authentication device 100 may provide the user with a user-specific target operation corresponding only to the verified biometric authentication S900.

In one example, if motion data is acquired from the motion recognition unit 120 within the waiting time, the motion authentication unit 143 may verify the motion authentication by comparing the acquired motion data with the motion loader data stored in the storage 160 S700. The motion loader data may refer to original motion data obtained along with original biometric data from a subscribed user for user authentication and stored in advance in the storage 160 in a corresponding manner to each original biometric data.

Thus, when the acquired biometric data and motion data are respectively identical with the biometric loader data and the motion loader data, it is verified that the motion authentication is successful. Further, if the acquired biometric data and/or motion data are not respectively identical with the biometric loader data and/or the motion loader data, it is verified that the motion authentication has failed.

Then, the user authentication device 100 may provide the user with a user-specific target operation corresponding to the motion authentication successfully verified by the motion authentication unit 143 S800.

A reason why the user authentication device 100 uses both the biometric authentication and the motion authentication may be enhancing the security or convenience for triggering the user-specific target operation.

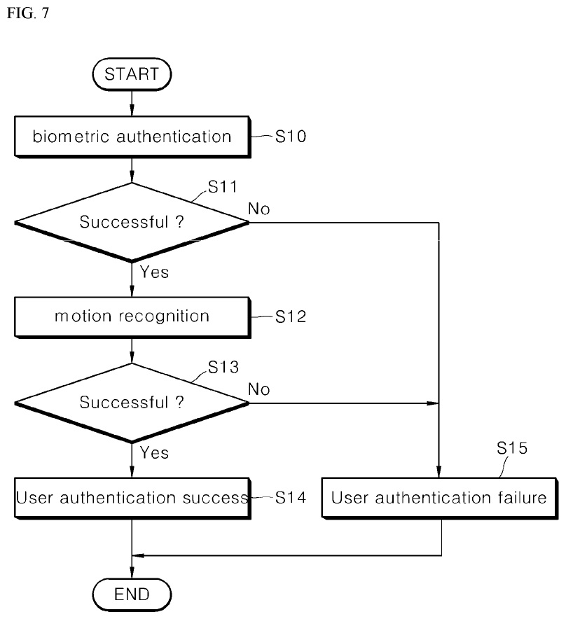

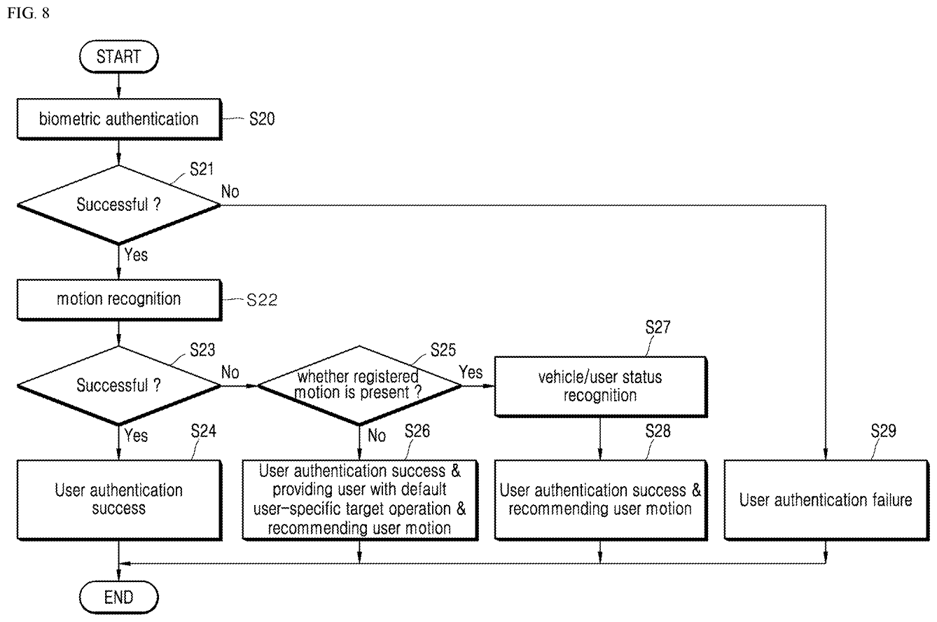

FIG. 7 is a flow chart to describe a user authentication method for triggering a user-specific target operation of the present disclosure for the enhanced security. FIG. 8 is a flow chart to identify a user authentication method for triggering a user-specific target operation of the present disclosure for the enhanced convenience.

Referring to FIG. 7, the biometric authentication unit 141 of the authentication unit 140 verifies biometric authentication of biometric data acquired by the biometric recognition unit 110 S10.

The biometric data may refer to template data having feature points or landmarks extracted from the biometric information. Biometric information may include fingerprints, veins, retinas, irises, voices, and images.

The biometric authentication unit 141 may verify the biometric authentication by comparing the obtained biometric data with biometric loader data stored in the storage 160. The biometric loader data refers to original biometric data obtained from the subscribed user for user authentication and stored in advance in the storage 160.

Thus, the biometric authentication unit 141 verifies that the biometric authentication is successful if the obtained biometric data and the biometric loader data are the same. Further, if the acquired biometric data and biometric loader data are not the same, the biometric authentication unit 141 may verify that the biometric authentication has failed.

When, from the verification result of the biometric authentication, the biometric authentication has failed S11, the biometric authentication unit 141 verifies that user authentication has failed S15.

When, from the verification result of the biometric authentication, the biometric authentication is successful S11, the motion authentication unit 143 of the authentication unit 140 verifies motion authentication of motion data acquired by the motion recognition unit 120 S12.

In this connection, the motion data may refer to template data having feature points or landmarks extracted from the motion information. The motion information may include gesture, text, position of touch point, shape and area.

The motion authentication unit 143 may verify motion authentication by comparing the acquired motion data with the motion loader data stored in the storage 160. The motion loader data refers to original motion data that is acquired with the original biometric data from a user subscribed for user authentication and stored in advance in the storage 160 in a corresponding manner to each original biometric data.

Then, if the acquired biometric data and motion data are respectively identical with the biometric loader data and motion loader data, it is verified that the motion authentication is successful. Alternatively, if the acquired biometric data and/or motion data are not respectively identical with the biometric loader data and motion loader data, it is verified that motion authentication has failed.

When, from the verification result of the motion authentication, the motion authentication has failed S13, the authentication unit 140 verifies that user authentication has failed S15.

When, from the verification result of the motion authentication, the motion authentication was successful S13, the authentication unit 140 finally verifies that the user authentication was successful S14.

As such, the user authentication device 100 may enhance security by preventing illegal authentication via double authentication procedures.

Referring to FIG. 8, the biometric authentication unit 141 of the authentication unit 140 verifies biometric authentication of biometric data acquired by the biometric recognition unit 110 S20.

The biometric data may refer to template data having feature points or landmarks extracted from the biometric information. Biometric information may include fingerprints, veins, retinas, irises, voices, and images.

The biometric authentication unit 141 may verify the biometric authentication by comparing the obtained biometric data with biometric loader data stored in the storage 160. The biometric loader data refers to original biometric data obtained from the subscribed user for user authentication and stored in advance in the storage 160.

Thus, the biometric authentication unit 141 verifies that the biometric authentication is successful if the obtained biometric data and the biometric loader data are the same. Further, if the acquired biometric data and biometric loader data are not the same, the biometric authentication unit 141 may verify that the biometric authentication has failed.

When, from the verification result of the biometric authentication, the biometric authentication has failed S21, the biometric authentication unit 141 verifies that user authentication has failed S29.

When, from the verification result of the biometric authentication, the biometric authentication is successful S21, the motion authentication unit 143 of the authentication unit 140 verifies motion authentication of motion data acquired by the motion recognition unit 120 S22.

In this connection, the motion data may refer to template data having feature points or landmarks extracted from the motion information. The motion information may include gesture, text, position of touch point, shape and area.

The motion authentication unit 143 may verify motion authentication by comparing the acquired motion data with the motion loader data stored in the storage 160. The motion loader data refers to original motion data that is acquired with the original biometric data from a user subscribed for user authentication and stored in advance in the storage 160 in a corresponding manner to each original biometric data.

Then, if the acquired biometric data and motion data are respectively identical with the biometric loader data and motion loader data, it is verified that the motion authentication is successful. Alternatively, if the acquired biometric data and/or motion data are not respectively identical with the biometric loader data and motion loader data, it is verified that motion authentication has failed.

When, from the verification result of the motion authentication, the motion authentication is successful S23, the authentication unit 140 verifies that both biometric authentication and motion authentication are successful S24. In this connection, the motion authentication refers to authentication for a motion registered by a user corresponding to the biometric authentication for the user-specific target operation selection. Therefore, if both biometric authentication and motion authentication are successful, the user authentication device 100 verifies that user the authentication succeeds and then may provide a corresponding user-specific target operation to the user.

To the contrary, when from the verification result of the motion authentication, it is verified that the motion authentication has failed S23, the motion verifying unit 142 may verify whether there is a registered motion corresponding to the verified biometric authentication, that is, the successfully verified biometric authentication S25. The pre-registered motion corresponding to the biometric authentication may be registered by the user and may be configured by the user. The registration of the motion may be performed by the user for selection of the user-specific target operation.

When, from the verification result, there is no registered motion corresponding to biometric authentication S25, the user authentication device 100 verifies that user authentication was successful only based on the biometric authentication and thus provides the user with a default user-specific target operation. That is, the user authentication device 100 may improve user convenience by configuring the level of the security based on the type of the user-specific target operation. That is, a user-specific target operation having a low level of the security may be quickly accessed. In other words, the user authentication device 100 may vary the type of the user-specific target operation to be accessed depending on a case where only the biometric authentication succeeds and the case where both the biometric authentication and the motion authentication succeed. In this connection, various types of default user-specific target operations may be available may be registered by each user.

Further, when there is not a registered motion corresponding to the biometric authentication, the motion recommending unit 152 may recommend a specific motion based on the environment data acquired by the environment recognition unit 130. That is, even when there is no registered motion, the user authentication device 100 may identify a motion pattern of the user before and after the authentication to guide the user to additionally register a specific motion when authenticating the user.

For example, the motion recommending unit 152 generates, as learned data, the frequency of the motions performed by the user under conditions such as vehicle position, current time, current weather, vehicle driving state, and self-driving state. Then, the motion recommending unit 152 extracts the most frequently used motion from the generated learned data under the current condition of the user or vehicle and recommend a motion most relevant to the verified biometric authentication.

When, from the verification result, there is a registered motion corresponding to the biometric authentication S25, the motion processing unit 150 of the user authentication device 100 may provide motion performance guidance information to the user so that the user performs the registered motion.

For this purpose, the user authentication device 100 may select and recommend a motion having a high use frequency based on the environment data acquired by the environment recognition unit 130. In this connection, the recommended motion may include a user motion which is selectable based on the environment data, or a motion that is easily recognized by the motion recognition unit 120 or a motion with the highest use frequency by the user under the environment data condition.

Then, when the motion data is acquired from the motion recognition unit 120, the motion authentication unit 143 may perform the motion authentication in the same manner as described in S22 and then verify that both biometric authentication and motion authentication are successful S28.

Therefore, when both biometric authentication and motion authentication are successful, the user authentication device 100 verifies that user authentication has succeeded and provides the corresponding user-specific target operations to the user.

As descried above, the convenience improvement may be achieved by varying the security level based on the type of the user-specific target operation. That is, a user-specific target operation having a low level of the security may be quickly accessed. In other words, the user authentication device 100 may vary the type of the user-specific target operation to be accessed depending on a case where only the biometric authentication succeeds and the case where both the biometric authentication and the motion authentication succeed.

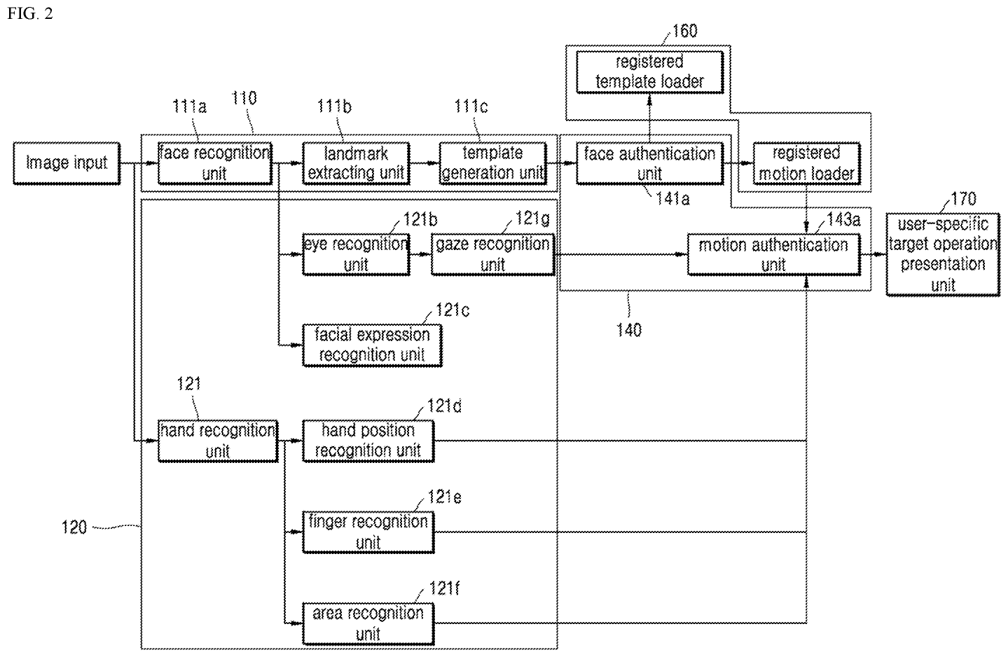

FIG. 2 illustrates an embodiment describing a user authentication method for triggering a user-specific target operation according to the present disclosure.

In this connection, for ease of description, it is assumed that both biometric authentication and motion authentication are successful. Therefore, when biometric authentication and motion authentication fail, user authentication failure may lead to execution termination.

Referring to FIG. 2, a face recognition unit 111a of the user authentication device 100 extracts a face image from an input image as imaged by a camera or the like for biometric recognition. Then, a landmark is extracted from the face image using a landmark extracting unit 111b. Then, the landmark is converted into a template (biometric data) by a template generation unit 111c.

In one example, an eye recognition unit 121b of the user authentication device 100 extracts an eye image from the face image from the face recognition unit 111a for motion recognition. Then, a gaze image is extracted from the eye image from the eye recognition unit 121b by a gaze recognition unit 121g. In this connection, the gaze refers to an area which the eye pupil points to. In one example, the gaze image may include nine areas corresponding to up, down, left, right, and diagonal directions to an exactly front direction. Further, a facial expression image is extracted from the face image from the face recognition unit 111a by a facial expression recognition unit 121c. In this connection, the facial expression image may include a position of a tail of a mouth, a shape of an eye or eyebrow, a shape and size of an eye/nose/mouth, and a protrusion of a zygoma.

Further, the user authentication device 100 may use a hand recognition unit 121 to extract a hand image from the input image for motion recognition. Then, a hand position is extracted from the extracted hand image by a hand position recognition unit 121d. Then, the number of extended fingers, the direction in which the fingers point, and the finger position are extracted from the extracted hand image by a finger recognition unit 121e. Further, an area recognition unit 121f extracts an area screened by the hand from the extracted hand image.

In this manner, the biometric recognition unit 110 of the user authentication device 100 recognizes the face image as biometric data. The motion recognition unit 120 recognizes the gaze image, the facial expression image, the hand image, the finger image and the area image as the motion data.

Subsequently, a face authentication unit 141a of the user authentication device 100 authenticates the face by comparing the biometric data generated by the template generation unit 111c with template loader data stored in the storage 160.

Then, a motion authentication unit 143a of the user authentication device 100 compares the hand motion data extracted from the motion recognition unit 120 with the motion loader data stored in the storage 160 to authenticate the hand motion. In this connection, the motion loader data may be registered for each user in response to the authenticated face information.

Table 1 below shows motion loader data registered for each user in response to face authentication.

TABLE 1

| User | Registered motion | User-specific target operation |
|---|---|---|
| Alice | Shaping “V with fingers in position | Vehicle start up |
| | right to face | |
| Alice | Shaping “L with fingers in position | Autonomous driving |
| | below jaw | execution |
| Alice | Stare at left side of cluster | Display scene right to vehicle |
| Alice | Stare at right side of cluster | Display scene left to vehicle |
| Carol | No registered motion | No |

Then, the user-specific target operation presentation unit 170 of the user authentication device 100 may provide the authenticated user with the corresponding user-specific target operation shown in Table 1.

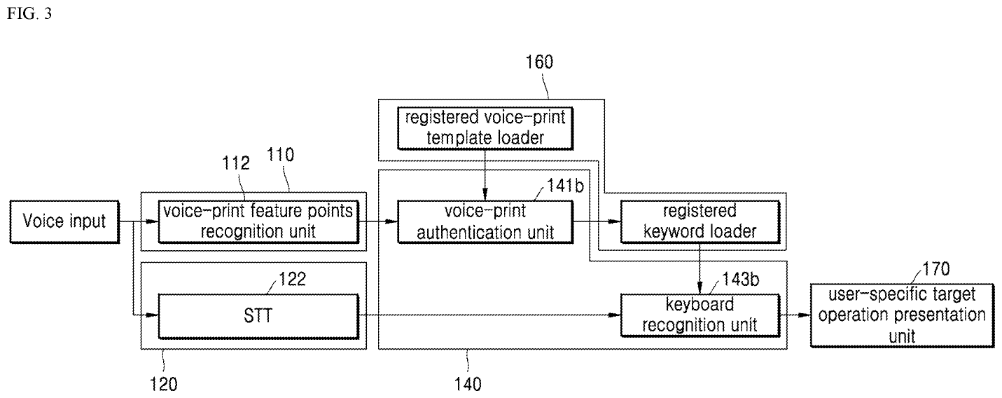

FIG. 3 shows another embodiment describing a user authentication method for triggering a user-specific target operation according to the present disclosure.

Referring to FIG. 3, a voice-print feature points recognition unit 112 of the user authentication device 100 extracts voice-print feature points data from a voice input from a microphone or the like for biometric recognition. Then, a voice recognition unit (STT) 122 of the user authentication device 100 converts and extracts spoken content from the input voice into text for motion recognition.

In this manner, the biometric recognition unit 110 of the user authentication device 100 recognizes voice-print feature points of biometric data. The motion recognition unit 120 recognizes a text as motion data.

Subsequently, the voice-print authentication unit 141b of the user authentication device 100 compares the voice-print feature point data extracted from the voice-print feature point recognition unit 112 with a template loader stored in the storage 160 to authenticate the voice-print.

Then, a keyboard recognition unit 143b of the user authentication device 100 compares the text from the voice recognition unit STT 122 with the motion loader data stored in the storage 160 to authenticate the text. In this connection, the motion loader data may be registered for each user in a corresponding manner to authenticated voice-print information.

Table 2 below shows motion loader data registered for each user in response to voice-print authentication.

TABLE 2

| User | Registered motion | User-specific target operation |
|---|---|---|
| Alice | Hi LG | Vehicle start up |
| Alice | Good morning LG | Autonomous driving |
| | | execution |
| Bob | Hi LG | News information guide |
| Bob | Good morning LG | Weather information guide |
| Carol | Hi LG | Schedule information guide |

Then, the user-specific target operation presentation unit 170 of the user authentication device 100 may provide a corresponding user-specific target operation shown in Table 2 to the user as authenticated.

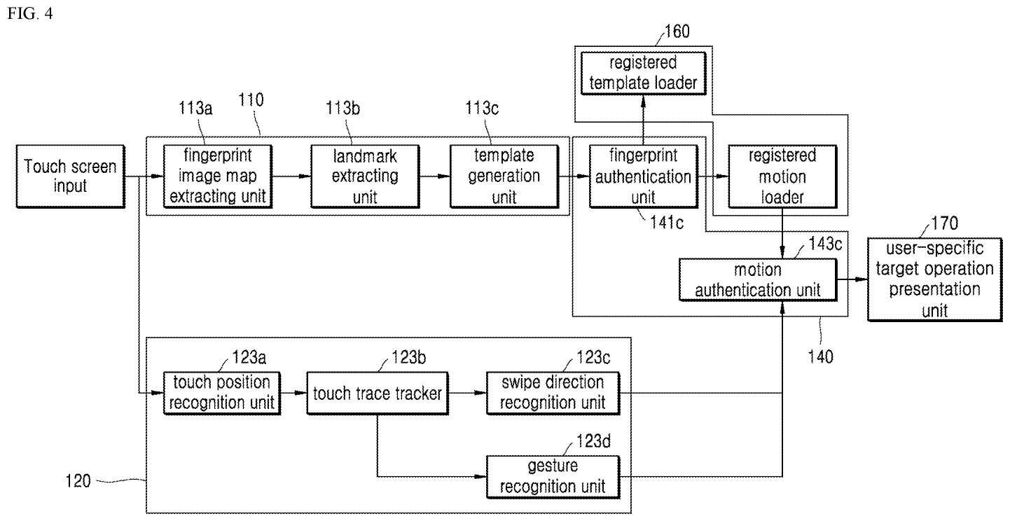

FIG. 4 is another embodiment describing a user authentication method for triggering a user-specific target operation according to the present disclosure.

Referring to FIG. 4, a fingerprint image map extracting unit 113a of the user authentication device 100 extracts an image map from a fingerprint image input from a touch screen or the like for biometric recognition. Then, the landmark is extracted from the image map by a landmark extracting unit 113b. Then, a template (biometric data) with landmarks is generated by a template generation unit 113c.

In one example, a touch position recognition unit 123a of the user authentication device 100 extracts a touch position of the touch screen for motion recognition. Then, a touch trace tracker 123b is used to extract a trajectory of a finger movement on the touch area of the touch screen. Then, a swipe (direction and shape) is extracted from the extracted trajectory by a swipe direction recognition unit 123c. Further, a gesture of the finger is extracted from the trajectory of the finger movement by a gesture recognition unit 123d.

In this manner, the biometric recognition unit 110 of the user authentication device 100 recognizes the fingerprint image as biometric data. The motion recognition unit 120 recognizes the swipe and gesture as the motion data.

Subsequently, The fingerprint authentication unit 141c of the user authentication device 100 authenticates the fingerprint by comparing the biometric data generated by the template generation unit 111c with the template loader stored in the storage 160.

Then, the motion authentication unit 143c of the user authentication device 100 authenticates the swipe motion by comparing the swipe or gesture extracted from the motion recognition unit 120 with motion loader data stored in the storage 160. In this connection, motion loader data may be registered for each user in a corresponding manner to authenticated fingerprint information.

Table 3 below shows motion loader data registered for each user in response to fingerprint authentication.

TABLE 3

| | | User-specific |
|---|---|---|
| User | Registered motion | target operation |
| Alice | Swipe in left direction | vehicle speed deceleration |
| Alice | Swipe in right direction | vehicle speed acceleration |
| Bob | Circle shaping | Vehicle start-up |
| Bob | Triangle shaping | vehicle stop |
| Carol | No registered motion | No |

Then, the user-specific target operation presentation unit 170 of the user authentication device 100 may provide the authenticated user with a corresponding user-specific target operations shown in Table 3.

In this connection, FIG. 2 to FIG. 4 show examples of performing the biometric authentication and motion authentication in the user authentication in a parallel manner. The present disclosure is not limited thereto. The biometric authentication and motion authentication may be performed sequentially.

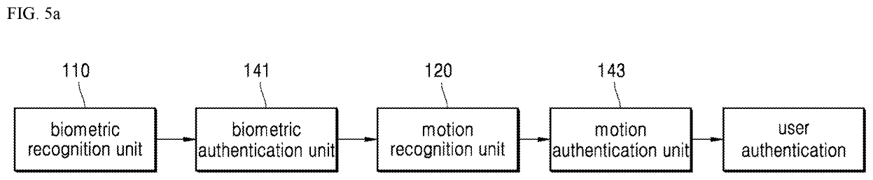

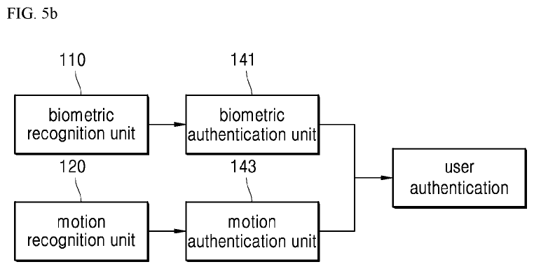

FIG. 5A illustrates an embodiment of sequentially performing biometric authentication and motion authentication in a user authentication device for triggering a user-specific target operation according to the present disclosure. FIG. 5b shows an embodiment of performing biometric authentication and motion authentication in parallel in a user authentication device for triggering a user-specific target operation according to the present disclosure.

That is, as shown in FIG. 5a, the biometric authentication unit 141 of the authentication unit 140 verifies the biometric authentication of the biometric data obtained by the biometric recognition unit 110.

Subsequently, the motion authentication unit 143 of the authentication unit 140 verifies the motion authentication of the motion data acquired by the motion recognition unit 120 based on the verification result of the biometric authentication as previously performed.

Then, the authentication unit 140 combines the biometric authentication and motion authentication results to verify the user authentication.

As such, when the biometric authentication and the motion authentication are sequentially performed, sensors for recognizing the registered motions for each user may be different from each other. In this case, a second authentication process may be performed by activating a sensor that recognizes the motion based on the results of biometric authentication.

Further, as shown in FIG. 5B, the biometric authentication unit 141 of the authentication unit 140 verifies biometric authentication of biometric data acquired by the biometric recognition unit 110.

At the same time, the motion authentication unit 143 of the authentication unit 140 verifies the motion authentication of the motion data acquired by the motion recognition unit 120 simultaneously with the biometric authentication.

The authentication unit 140 verifies the user authentication by combining the biometric authentication and motion authentication results.

As such, when the biometric authentication and the motion authentication are performed in parallel, the motion recognition sensor may be fixed. In this case, a second authentication process may be used at the same time. Alternatively, all of sensors for the second authentication process may be activated and then the second authentication result may be used simultaneously using a result from recognizing a corresponding motion.

As described above, the biometric authentication and motion authentication processes may be performed sequentially or in parallel. In both cases, the same result may be output. However, the sequential or parallel manner may be selected in consideration of a response speed improvement, a sensor power save, and complication.

Although the present disclosure has been described with reference to the drawings and embodiments as exemplified above, the present disclosure is not limited to the embodiments and the drawings disclosed herein. It is obvious that various modifications may be made thereto by a person skilled in the art within the scope of the present disclosure. In addition, it should be appreciated that effects to be achieved from configurations of the present disclosure as not expressly mentioned may be acknowledged.

What is claimed is:

1. A user authentication device comprising:
a recognition unit configured for extracting biometric information and motion information of a user and environment information including vehicle and user status to obtain at least one of biometric data, motion data, or environment data;
an authentication unit configured for:
comparing at least one of the obtained biometric data or motion data with previously stored loader data;
verifying biometric authentication and/or motion authentication based on the comparison result; and
performing user authentication based on the verification result;
a motion processing unit configured for, when the biometric authentication is successful and a pre-registered motion corresponding to the successful biometric authentication is present, notifying the pre-registered motion to the user; and
a user-specific target operation presentation unit configured for presenting, to the user, a pre-stored user-specific target operation based on the user authentication result.

2. The user authentication device of claim 1, wherein the recognition unit includes:
a biometric recognition unit configured for extracting the biometric information of the user to obtain the biometric data;
a motion recognition unit configured for extracting the motion information of the user to obtain the motion data; and
an environment recognition unit configured for extracting environment information around the user to obtain the environment data.

3. The user authentication device of claim 1, wherein the motion processing unit is further configured for:
when the pre-registered motion corresponding to the successful biometric authentication is absent, informing the user of a specific motion, wherein the specific motion includes at least one of:
a motion selectable based on the environmental data before and after the biometric authentication;
a motion having a highest use frequency by the user; or
a motion easily recognizable by the recognition unit.

4. The user authentication device of claim 1, wherein the authentication unit includes:
a biometric authentication unit configured for verifying biometric authentication by comparing the acquired biometric data with previously stored biometric loader data;
a motion authentication unit configured for verifying motion authentication by comparing the acquired motion data with previously stored motion loader data; and
a registered motion verifying unit configured for checking, when the motion data is not obtained, whether the pre-registered motion corresponding to the successful biometric authentication is present.

5. The user authentication device of claim 4, wherein when there is no pre-registered motion corresponding to the successful biometric authentication, the authentication unit is configured to authenticate the user only based on the biometric authentication result from the biometric authentication unit.

6. The user authentication device of claim 4, wherein when there is the pre-registered motion corresponding to the successful biometric authentication, the authentication unit is further configured to wait for a predefined time until the pre-registered motion is input thereto.

7. The user authentication device of claim 1, wherein the motion processing unit includes:
a motion guiding unit configured for notifying a motion information guide to the user to input the pre-registered motion or a specific motion; and
a motion recommending unit configured for recommending, to the user, a registered motion or a specific motion based on the obtained environment data.

8. The user authentication device of claim 7, wherein the motion recommending unit is further configured for recommending, to the user, at least one of:
a motion selectable based on the environmental data;
a motion having a highest use frequency by the user under the environmental data; or
a motion easily recognizable by a motion recognition unit.

9. The user authentication device of claim 1, wherein the authentication unit is further configured to perform the biometric authentication and the motion authentication sequentially.

10. The user authentication device of claim 1, wherein the authentication unit is further configured to perform the biometric authentication and the motion authentication in a parallel manner.

11. A user authentication method comprising:
extracting, by a recognition unit, biometric information and motion information of a user and environment information including vehicle and user status to obtain at least one of biometric data, motion data, or environment data;
comparing, by an authentication unit, at least one of the obtained biometric data or motion data with previously stored loader data;
verifying, by the authentication unit, biometric authentication and/or motion authentication based on the comparison result;
performing, by the authentication unit, user authentication based on the verification result;
when the biometric authentication is successful and a pre-registered motion corresponding to the successful biometric authentication is present, notifying, by the motion processing unit, the pre-registered motion to the user; and
presenting, by a user-specific target operation presentation unit, to the user, a pre-stored user-specific target operation based on the user authentication result.

12. The user authentication method of claim 11, wherein the method further includes:
when the pre-registered motion corresponding to the successful biometric authentication is absent, informing, by the motion processing unit, to the user, a specific motion, wherein the specific motion includes at least one of:
a motion selectable based on the environmental data before and after the biometric authentication;
a motion having a highest use frequency by the user; or
a motion easily recognizable by the recognition unit.

13. The user authentication method of claim 12, wherein informing the user of the specific motion or the pre-registered motion includes:
notifying, by a motion guiding unit, a motion information guide to the user to input a registered motion or a specific motion; and
recommending, by a motion recommending unit, to the user, a registered motion or a specific motion based on the obtained environment data.

14. The user authentication method of claim 13, wherein recommending, by the motion recommending unit, to the user, the registered motion or the specific motion based on the obtained environment data includes:
recommending, by the motion recommending unit, to the user, at least one of:
a motion selectable based on the environmental data;
a motion having a highest use frequency by the user under the environmental data; or
a motion easily recognizable by a motion recognition unit.

15. A user authentication method comprising:
acquiring biometric data from biometric information extracted from a biometric recognition unit;
verifying, by a biometric authentication unit, biometric authentication by comparing the biometric data with previously stored biometric loader data;
verifying, by a registered motion verifying unit, whether there is a registered motion corresponding to a successful biometric authentication;
when, upon the verification result, there is no registered motion corresponding to the biometric authentication, providing a user with a user-specific target operation corresponding to the biometric authentication;
when, the verification result, there is a registered motion corresponding to the biometric authentication, extracting, by a motion recognition unit, motion information to obtain motion data;
verifying, by a motion authentication unit, motion authentication by comparing the acquired motion data with previously stored motion loader data; and
providing a user with a user-specific target operation corresponding to the successfully verified motion authentication.

16. The user authentication method of claim 15, wherein extracting the motion information to obtain the motion data includes:
when the motion data is not acquired after a predefined time has lapsed, providing the user with a user-specific target operation corresponding to the successful biometric authentication.

17. The user authentication method of claim 16, wherein verifying the motion authentication includes:
when the motion data is not obtained or when the obtained motion data is not a registered motion, providing, by a motion processing unit, motion performance guide information to the user to perform a registered motion.

18. The user authentication method of claim 15, wherein the method further includes:
when the registered motion corresponding to the successful biometric authentication is absent, informing, by a motion processing unit, to the user, a specific motion, wherein the specific motion includes at least one of:
a motion selectable based on the environmental data before and after the biometric authentication;
a motion having a highest use frequency by the user; or
a motion easily recognizable by the recognition unit.

19. The user authentication method of claim 14, wherein the method further includes:
after providing the motion performance guide information, waiting for a predetermined time until motion data is acquired;
when no motion data is acquired after the predetermined time has lapsed, determining, by an authentication unit, that the user does not perform separate motion authentication; and
providing the user with a user-specific target operation corresponding to the successful biometric authentication.

20. The user authentication method of claim 18, wherein the method further includes recommending, by a motion recommending unit, to the user, a registered motion or a specific motion,
wherein recommending the motion includes:
generating, as learned data, an execution frequency of a motion by the user based on at least one of a vehicle position, a current time, a current weather, a vehicle driving state, and a self-driving state;
extracting a most frequently executed motion from the generated learned data under a current condition of user or vehicle; and
recommend a motion most relevant to the successful biometric authentication.
